(19) United States
(12) Patent Application Publication
(10) Pub. No.: US 2025/0150654 A1
(43) Pub. Date: May 8, 2025

(54) Framework for Simultaneous Subject and Desk Capture During Videoconferencing

(71) Applicant: Apple Inc., Cupertino, CA (US)

(72) Inventors: Jianping Zhou, Cupertino, CA (US); Fiona P. O'Leary, Palo Alto, CA (US); Julio C. Hernandez Zaragoza, Cupertino, CA (US); Lukas Girling, Stoke Bishop (GB)

(21) Appl. No.: 18/867,930

(22) PCT Filed: May 30, 2023
(86) PCT No.: PCT/US2023/023891

§ 371 Date: Nov. 21, 2024

Related U.S. Application Data
(60) Provisional application No. 63/365,801, filed on Jun. 3, 2022.

(51) Int. Cl. H04N 21/2343; G06T 3/18; G06T 3/60; G06T 7/70; G06V 10/82; G06V 40/16

(52) U.S. Cl. CPC H04N 21/234345; G06T 3/18; G06T 3/60; G06T 7/70; G06V 10/82; G06V 40/161

(57) ABSTRACT

Devices, methods, and non-transitory program storage devices are disclosed herein to: obtain, at a first electronic device, one more images captured by a first image capture device; crop a first portion of a first image of the one or more images, e.g., comprising a face of a human subject; apply a distortion correction operation to the cropped first portion; and then crop a second portion of the first image, wherein the second portion comprises a portion of a surface (e.g., a desktop or document) in the first image; apply a distortion correction operation to the cropped second portion; and transmit the distortion-corrected first and second portions to a second electronic device, e.g., after compositing the first and second portions into an output image to be transmitted. The first image capture device may be integrated into the first electronic device, or it may be connected in a wired or wireless fashion.

### TECHNICAL FIELD

This disclosure relates generally to the field of image processing. More particularly, but not by way of limitation, it relates to cropping and distortion correction techniques, e.g., for the streaming of video image data.

### BACKGROUND

The advent of portable integrated computing devices has caused a wide proliferation of cameras and other video capture-capable devices. These integrated computing devices commonly take the form of smartphones, tablets, or laptop computers, and typically include general purpose computers, cameras, sophisticated user interfaces including touch-sensitive screens, and wireless communications abilities through Wi-Fi, Bluetooth, LTE, HSDPA, New Radio (NR), and other cellular-based or wireless technologies. The wide proliferation of these integrated devices provides opportunities to use the devices' capabilities to perform tasks that would otherwise require dedicated hardware and software.

For example, integrated computing devices, such as smartphones, tablets, and laptop computers typically have one or more embedded cameras. These cameras generally amount to lens/camera hardware modules that may be controlled through the use of a general-purpose computer using firmware and/or software (e.g., “Apps”) and a user interface, including touch-screen buttons, fixed buttons, and/or touchless controls, such as voice control. The integration of high-quality cameras into these integrated communication devices, such as smartphones, tablets, and laptop computers, has enabled users to capture and share images and videos in ways never before possible. It is now common for users' smartphones to be their primary image capture device of choice.

Along with the rise in popularity of photo and video sharing via personal computing devices having integrated cameras has come a rise in videoconferencing via such computing devices. In particular, users may often engage in videoconferencing sessions or other virtual meetings, with the video images typically captured by a front-facing camera on the device, i.e., a camera that faces in the same direction as the camera device's display screen. Most prior art cameras are optimized for either wide-angle, general photography or for narrower-angle photography (e.g., self-portraits and videoconferencing streaming use cases). Those cameras that are optimized for wide angles are typically optimized for group and landscape compositions, but are not optimal for individual portraits, due, e.g., to the distortion that occurs when subjects are at short distances from the camera or at the edges of the camera's field of view.

“Field of view” or “FOV,” as used herein, refers to the angular extent of a given scene that is imaged by a camera. FOV is typically measured in terms of a number of degrees, and may be expressed as a vertical FOV, horizontal FOV, and/or diagonal FOV. The diagonal FOV of the image sensor is often referred to, as it is a more relevant measure of the camera's optics, since it attempts to cover the corners of the image, where “roll off,” i.e., vignetting, problems associated with pixels at the corners of the image sensor may become more pronounced. For reference, a typical 35 mm camera with a lens having a focal length of 50 mm will have a horizontal FOV of 39.6°, a vertical FOV of 27.0°, and a diagonal FOV of 46.8°. By contrast, a typical “wide” FOV camera may have a diagonal FOV of greater than or equal to 70°, though there is no single definition of what constitutes a “wide” FOV camera. Some so-called “ultra-wide” FOV cameras may even have diagonal FOVs of greater than 100°, providing for the capture of larger and larger scenes—but often at the expense of reduced image quality and/or greater distortion, especially around the peripheral areas of the lens's FOV.

Cameras that are optimized for portraits and video conference streaming (e.g., “front-facing” cameras) are not typically optimal for landscapes, group photos (or group videoconferencing sessions), or other wide-angled scenes, because of their limited field of view. The field of view of a given camera also may influence how the user composes the shot (i.e., how far away and at what angle they position themselves and/or other objects in the captured scene with respect to the camera) and the quality of the image that is ultimately captured by the camera. Additionally, certain devices that may be the most comfortable or appropriate for a user to utilize during a lengthy videoconferencing call, e.g., a desktop computer with a standalone monitor or a laptop computer, may either have no integrated camera or a low-quality, integrated web camera, often with a limited FOV.

Moreover, users may often desire to capture portions of a surface that is present in the captured scene, e.g., a desktop surface or other region in the scene, from which the user may be presenting or referencing a document or other object during the videoconference session. It may also be desirable to capture and transmit a view of the user's face simultaneously with the capture and transmission of the view of the aforementioned surface in the scene, e.g., as the user may be explaining the contents of a document that is on a desk surface to the other participants of the videoconferencing session.

Thus, in order to provide users with greater flexibility in the content they can capture and transmit during videoconferencing sessions—and the ability to leverage higher-quality and/or wider FOV image capture devices—it would be desirable to have methods and systems that provide such users with the ability to automatically detect, crop, and apply independent distortion correction operations to various portions of captured images, thereby allowing for the simultaneous streaming of different, distortion-corrected portions of video images that are captured by one or more image capture devices to the participants of the videoconferencing session.

### SUMMARY

Devices, methods, and non-transitory program storage devices (NPSDs) are disclosed herein to: obtain, at a first electronic device, one more images captured by a first image capture device (e.g., a video image stream); crop a first portion of a first image of the one or more images (e.g., according to one or more predetermined framing rules), wherein the first portion comprises a face of a human subject in the first image; apply a first distortion correction operation to the first portion; and then crop a second portion of the first image, wherein the second portion comprises a portion of a surface (e.g., a desktop or document) in the first image; apply a second distortion correction operation to the second portion; and, finally, transmit the distortion-corrected first and second portions to a second electronic device. In some implementations, the first and second portions may be composited into a single output image before being transmitted. The first image capture device may be integrated or embedded directly into the first electronic device, or it may be connected to the first electronic device in a wired or wireless fashion. In other cases, different image capture devices may be used to capture the first and second portions.

In some embodiments, the first and second distortion correction operations that are applied may be different distortion correction operations, e.g., different types or combinations of distortion correction operations, or similar distortion correction operations using different parameters. In other embodiments, the second distortion correction orientation may even be further based on an estimated orientation (e.g., tilt) of the portion of the surface in the first image. In still other embodiments, an occlusion detection operation may be performed on the second portion, and then at least one detected occlusion may be excluded from the second distortion correction operation (and/or have a strength of the second distortion correction operation be reduced in the region of the detected occlusion).

In some embodiments, the techniques described herein may also obtain orientation information (e.g., roll, pitch, and/or yaw) associated with the first image capture device during the capture of each of the one or more images. In some such embodiments, the second distortion correction operation may then comprise applying a rotation operation (e.g., a “virtual” rotation operation performed via software) to the second portion, based, at least in part, on orientation information associated with the first image capture device during the capture of the first image.

In other embodiments, the second portion of the first image may be detected automatically via the application of a surface detector (e.g., a document or rectangle detector) to the first image. For example, the detector may comprise a deep neural network (DNN) trained to locate particular surfaces in images. In some such embodiments, a location and size of the portion of the surface may be tracked across the one or more images captured by the first image capture device, e.g., by repeated application of the aforementioned detector, so that the cropped second portion continues to include the desired document or other surface-related content over the duration of the capture of the one or more images of a videoconferencing session.

In some cases, the portion of the surface may comprise two or more non-contiguous regions in the first image. In still other cases, the portion of the surface may be initially defined by a user gesture (e.g., a hand or body gesture, or a gesture performed with another user input device) that is captured at the first image capture device (and then tracked throughout the captured scene over time, e.g., as described above with reference to the detector).

Additional devices, methods, and NPSDs are disclosed herein to: obtain one more images captured by a first image capture device of an electronic device; crop a first portion of a first image of the one or more images, wherein the first portion comprises a face of a human subject in the first image; apply a first distortion correction operation to the first portion; crop a second portion of the first image of the one or more images, wherein the second portion comprises a portion of a surface in the first image; apply a second distortion correction operation to the second portion, wherein the second distortion correction operation comprises applying a rotation operation to the second portion, based, at least in part, on orientation information obtained from a first positional sensor of the electronic device and associated with the capture of the first image; and then transmit the distortion-corrected first portion and the distortion-corrected second portion to another electronic device.

Further devices, methods, and NPSDs are disclosed herein to: obtain a first sequence of images captured by a first image capture device; crop a first portion of a first image of the first sequence of images, wherein the first portion comprises a face of a human subject in the first image; apply a first distortion correction operation to the first portion; obtain a second sequence of images captured by a second image capture device; crop a second portion of a second image of the second sequence of images, wherein the second portion comprises a portion of a surface in the second image, and wherein the second image corresponds in time to the first image; apply a second distortion correction operation to the second portion, wherein the second distortion correction operation comprises applying a rotation operation to the second portion; and transmit the distortion-corrected first portion and the distortion-corrected second portion to another electronic device.

Various non-transitory program storage device embodiments are also disclosed herein. Such NPSDs are readable by one or more processors. Instructions may be stored on the NPSDs for causing the one or more processors to perform any of the embodiments disclosed herein. Various image processing and secure device connection methods are also disclosed herein, in accordance with the device and NPSD embodiments disclosed herein.

### BRIEF DESCRIPTION OF THE DRAWINGS

FIG. 1 illustrates an exemplary setup for simultaneous subject and desk capture during videoconferencing, according to one or more embodiments.

FIG. 2 illustrates exemplary distortion correction operations, according to one or more embodiments.

FIG. 3 illustrates exemplary device configurations for simultaneous subject and desk capture during videoconferencing, according to one or more embodiments.

FIG. 4 illustrates exemplary distortion correction operations for a multi-document scene, according to one or more embodiments.

FIGS. 5A-5C are flow charts illustrating various methods of performing simultaneous subject and desk capture during videoconferencing, according to various embodiments.

FIG. 6 is a block diagram illustrating a programmable electronic computing device, in which one or more of the techniques disclosed herein may be implemented.

### DETAILED DESCRIPTION

In the following description, for purposes of explanation, numerous specific details are set forth in order to provide a thorough understanding of the inventions disclosed herein. It will be apparent, however, to one skilled in the art that the inventions may be practiced without these specific details. In other instances, structure and devices are shown in block diagram form in order to avoid obscuring the inventions. References to numbers without subscripts or suffixes are understood to reference all instance of subscripts and suffixes corresponding to the referenced number. Moreover, the language used in this disclosure has been principally selected for readability and instructional purposes and may not have been selected to delineate or circumscribe the inventive subject matter, and, thus, resort to the claims may be necessary to determine such inventive subject matter. Reference in the specification to “one embodiment” or to “an embodiment” (or similar) means that a particular feature, structure, or characteristic described in connection with the embodiments is included in at least one embodiment of one of the inventions, and multiple references to “one embodiment” or “an embodiment” should not be understood as necessarily all referring to the same embodiment.

### Exemplary Setup for Simultaneous Subject and Desk Capture During Videoconferencing

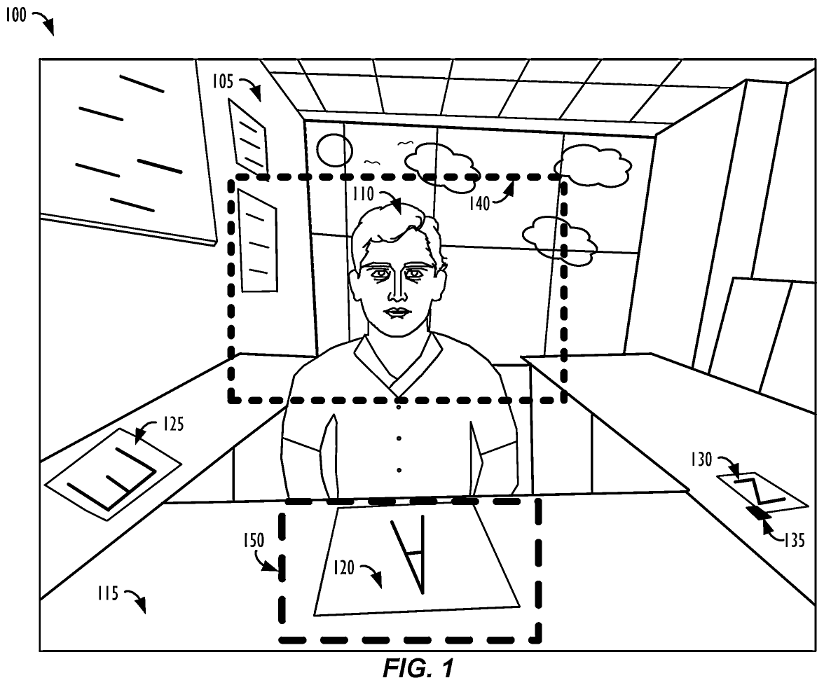

Turning now to FIG. 1, an exemplary setup for simultaneous subject and desk capture during videoconferencing is shown, according to one or more embodiments. Image 100 represents a wide FOV (e.g., having a diagonal FOV of roughly 120°) image capture of an exemplary scene. As will be explained in greater detail herein, image 100 may be captured by, e.g., an image capture device of an electronic device that is hosting or managing an active videoconferencing session, or an image capture device of an electronic device that is wired or wirelessly connected to the electronic device that is hosting or managing the active videoconferencing session.

The exemplary scene captured in image 100 comprises a human subject 110, a desktop surface 115, various documents placed on surfaces within the scene (120/125/130), other objects (135) that may occlude portions of documents placed on surfaces within the scene, and various other walls (105), objects, windows, furniture, etc., within the scene. In the exemplary videoconference session being described here in the context of FIG. 1, the human subject 110 may wish to transmit portions of his own face, as well as one or more of the documents placed on surfaces within the scene (120/125/130).

According to some embodiments, a first portion (140) of image 100 may be determined and cropped from the image 100. In this example, of the first portion comprises the face of a human subject 110 in the image 100. According to some embodiments, the exact size, location, boundaries, aspect ratio, etc., of first portion 140 may be determined according to one or more predetermined framing rules. For example, the one or more predetermined framing rules may specify that the face of the human subject take up no more than a predetermined percentage of the width and/or a predetermined percentage of the height of the first portion 140. In other embodiments, one or more predetermined framing rules may specify that the bounds of the first portion 140 are determined directly by one or more measurements related to the human subject, e.g., a size of the human subject's face, a width of the human subject's forehead or shoulders, a distance between the eyes of the human subject, and so forth. In other embodiments, one or more predetermined framing rules may specify that the placement of certain features of the human subject relative to the first portion 140, e.g., with the cropping location of the first portion 140 selected so that the eyes of the human subject appear at a certain distance away from a top edge of the first portion 140, e.g., one-half, one-third, or one-fourth of the vertical extent of the first portion 140 away from the top edge of the first portion 140. In other embodiments, the one or more predetermined framing rules may specify an amount of padding required between the extent of the human subject's face and the boundaries of first portion 140. In still other embodiments, the first portion 140 may be configured with framing rules configured to frame more than one human subject in an aesthetically-pleasing manner, e.g., similar to the various exemplary framing rules described above.

According to some embodiments, a second portion (150) of image 100, e.g., a second portion comprising a portion of a surface in the captured scene, may also be determined and cropped from the image 100. In the example of FIG. 1, a desktop surface 115 has been identified in the image 100. As may now be appreciated, due to the wide FOV of the camera used to capture exemplary image 100, the image 100 may comprise portions of both a human subject's face, as well as one or more documents on surfaces in the scene, which may be substantially lower than the height of the human subject's face within the scene—as well as rotated downwardly by 90° or more from the plane in the scene on which the face of the human subject appears. That is, the face of the human subject 110 may be pointing towards a wall in the room (and, in this example of FIG. 1, towards the lens of the camera used to capture the scene), while the desktop surface 115 (and documents 120/125/130 placed upon it) may be pointing towards the ceiling in the room (and, in this example of FIG. 1, perpendicular to the direction that the lens of the camera used to capture the scene is facing).

The size, location, boundaries, aspect ratio, etc., of the second portion 150 may be determined according to various schemes. For example, in some cases, the second portion 150 may simply be determined to cover a pre-selected or user-specified portion of the scene (e.g., a portion having a particular size, shape, and/or aspect ratio). For example, a rectangle covering the bottom 20%, 30%, or 40% of the captured images, or the like. In other cases, a surface detector may be run on the captured images, and the second portion 150 may be determined to encompass one surface in the scene, all surfaces in the scene, the largest surface in the scene, etc. In still other embodiments, other trained detectors, e.g., rectangle detectors, document detectors, or the like may be run on the captured images, and the second portion 150 may be determined to encompass one document/rectangle in the scene, all document/rectangles in the scene, the largest document/rectangle in the scene, etc. For example, in some cases, the detector may comprise a deep neural network (DNN) trained to locate particular types of surfaces or objects in captured images. In some such embodiments, a location and size of the portion of the detected surface may be tracked across the one or more images captured by the first image capture device, e.g., by repeated application of the aforementioned detector, so that the cropped second portion 150 continues to include the desired document or other surface-related content over the duration of the capture of the one or more images of a videoconferencing session—even if the human subject moves around the desired document or other surface-related content during the videoconferencing session.

In still other embodiments, the second portion 150 to be cropped from the image 100 may be initially defined by a user gesture (e.g., a hand or body gesture pointing to or defining the perimeter of the second portion, or a gesture performed with another user input device, such as a mouse defining the boundaries of the second portion in a captured image displayed on a display screen of the electronic device) that is captured at the first image capture device. The initially—defined second portion may then tracked throughout the captured scene over time, e.g., as described above with reference to the detector. Gestures may also be used to indicate to an electronic device to track more (or fewer) individual documents located on an identified desktop surface in the scene, as well as to turn on or off the simultaneous subject and desktop capture features described herein altogether (e.g., to return to a “standard” videoconferencing session that only transmits images of the human subject(s) in the scene).

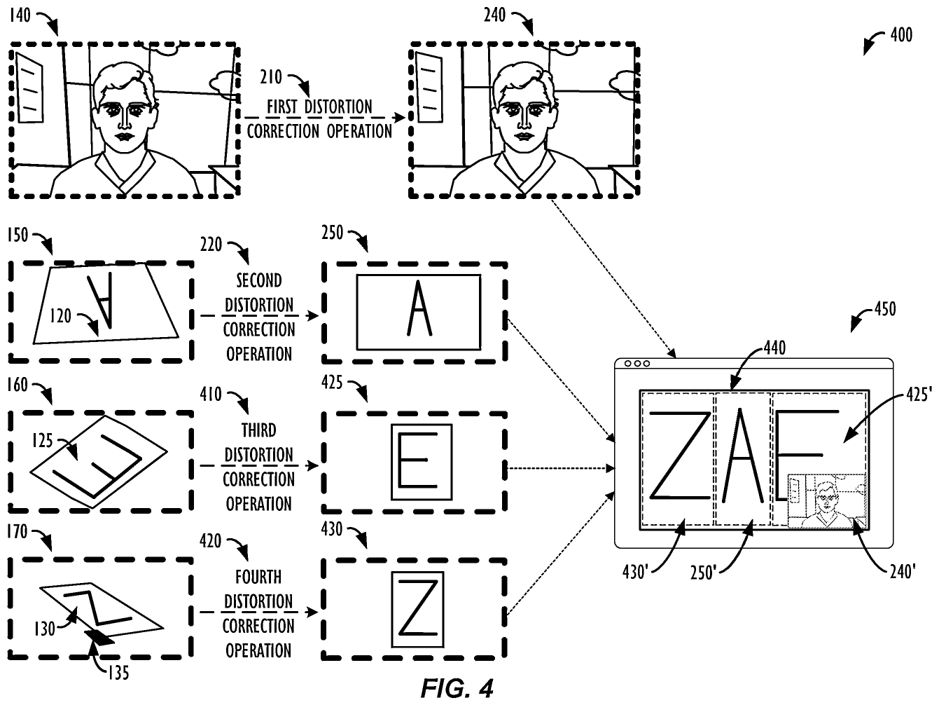

As will be described in greater detail below with reference to FIG. 4, it is to be understood that it also may be possible for the second portion 150 to include or combine multiple, non-contiguous regions within the scene captured in the image, e.g., additional documents 125 and 130 may also be included in the second portion 150 along with document 120. Further, the first and second portions could also comprise other specified combinations of types of portions within the captured scene. For example, the first and second portions could comprise: the face of a human subject and a clock within the captured scene; a desktop surface and a clock within the captured scene; or a face of a human subject and the hands of the human subject; the faces of two different human subject in the captured scene, etc.

### Exemplary Distortion Correction Operations for Simultaneous Subject and Desk Capture During Videoconferencing

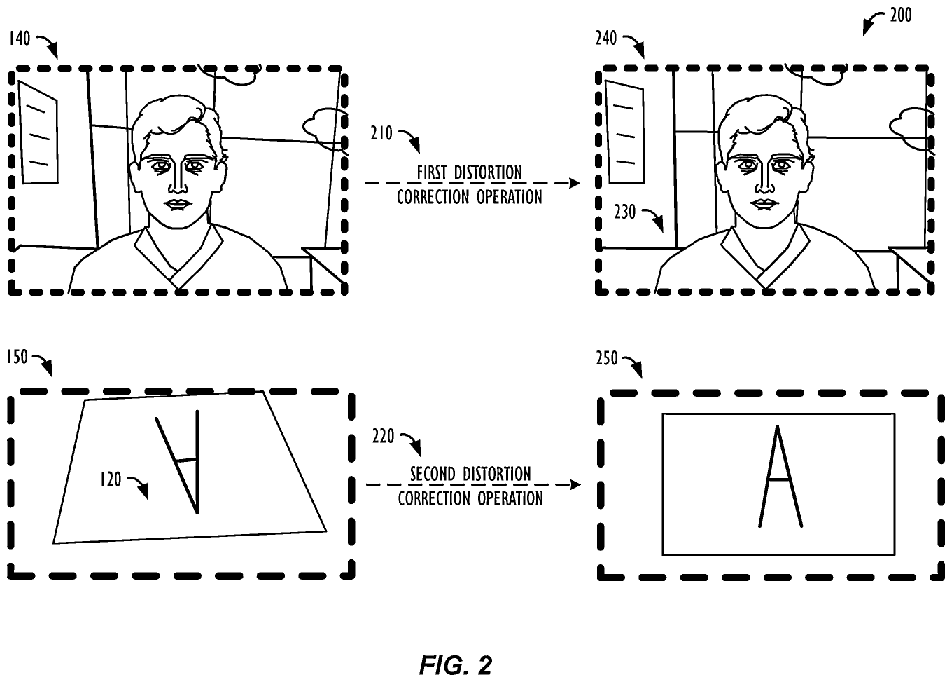

Turning now to FIG. 2, exemplary distortion correction operations 200 are shown, according to one or more embodiments. Beginning with first cropped image portion 140, which comprises the face of human subject 110 from FIG. 1, a first distortion correction operation 210 may be applied to first cropped image portion 140, resulting in a distortion-corrected first cropped image portion 240. In some embodiments, first distortion correction operation 210 may comprise a perspective distortion correction, barrel lens distortion correction, a geometric distortion correction, or the like. For example, in FIG. 2, exemplary first distortion correction operation 210 may be evidenced at element 230 in distortion-corrected first cropped image portion 240, wherein various lines and edges that were slanted in first cropped image portion 140 have been warped to become straight lines in distortion-corrected first cropped image portion 240.

Turning to second cropped image portion 150, which comprises a portion of a surface from image 100 from FIG. 1 (in this example, the portion of the surface includes a document 120 that was on the desktop surface 115), a second distortion correction operation 220 may be applied to second cropped image portion 150, resulting in a distortion-corrected second cropped image portion 250. In some embodiments, second distortion correction operation 220 may comprise a fisheye distortion correction, a perspective distortion correction, barrel lens distortion correction, a geometric distortion correction, a rotation operation (e.g., a “virtual” rotation operation, capable of being performed in software), a keystone distortion correction operation, or the like. For example, in FIG. 2, exemplary second distortion correction operation 220 may be evidenced in a distortion-corrected second cropped image portion 250 via the fact that the text on document 150 (i.e., the letter ‘A’) has been rotated to become upright, and the shape of the document 150, which had various lines and edges that were slanted in second cropped image portion 150 have been rectified to become a rectangle with straight (or, at least, straighter) lines in distortion-corrected second cropped image portion 250, i.e., the document 120 is made to appear after the distortion correction operation as if it were located directly in front of the image capture device in the scene (i.e., rather than on a flat surface rotated down approximately 90 degrees from the central axis of the image capture device).

### Examples of Device Configurations for Simultaneous Subject and Desk Capture During Videoconferencing

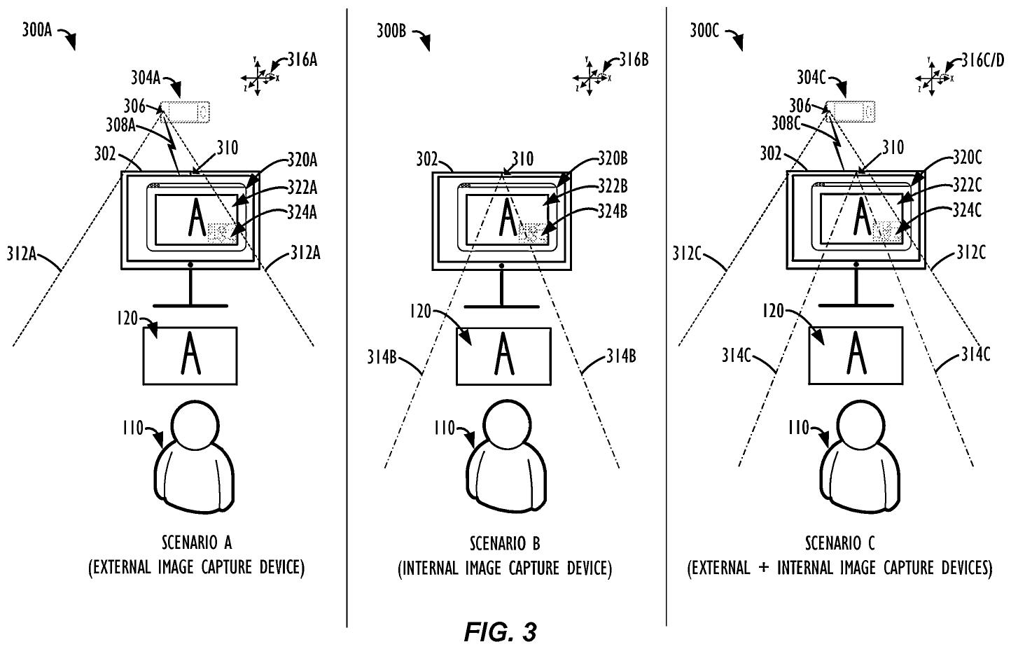

Turning now to FIG. 3, examples of device configurations 300A-300C for simultaneous subject and desk capture during videoconferencing are shown, according to one or more embodiments. In example 300A, a first device (304A) and a second device (302) are in proximity to one another and have formed a secure connection with each other 308A (in this case, a wireless connection). In some embodiments, first device (304A) may comprise one or more image capture devices (306), and second device (302) may also comprise one more image capture devices (310). In some cases, an image capture device 306 of the first device may be of a higher quality than the image capture device(s) 310 of the second device, e.g., in terms of resolution, zoom, FOV, spatial resolution, focus, color quality, or any other imaging parameter. In such cases, it may be more desirable to use the external image capture device 306 of the first device rather than the image capture device 310 of the second device to capture images to be used, displayed, stored, transmitted, etc., by the second device (302), e.g., as part of an active videoconferencing session. In still other cases, a user of the second device (302) may simply desire to select an image capture device of the first device (304A) for any number of other reasons, e.g., to provide a different (and/or additional) view of the scene around the second device (302) (e.g., including a portion of one or more surfaces present in the scene), because the second device (302) may not have an image capture device of its own, because an image capture device of the second device (302) is not functioning properly, because an image capture device of the first device (304A) may have a special image capture capability or mode desired by the user of the second device (e.g., an “Ultrawide” photography mode), and so forth. According to some embodiments, the first device must meet a first set of device state criteria (e.g., being in a particular orientation and/or within a particular distance of the second device 302) before establishing a connection with the second device.

As shown in example 300A, the image capture device 306 of the first device (304A) has a wide FOV, represented by dashed lines 312A, which is capable of capturing both exemplary human subject 110 and exemplary document 120. As described above with reference to FIGS. 1 and 2 (and as will be described in greater detail below with reference to FIG. 4), in some embodiments, the distortion-corrected first portion of the captured scene comprising human subject 110 (labeled 324A) may be composited with (e.g., overlaid on top of or placed next to) the distortion-corrected second portion of the captured scene comprising exemplary document 120 (labeled 322A) and then displayed, stored, and or transmitted to another electronic device, e.g., via a video conferencing application (labeled 320A).

Coordinate axis 316A also reflects the fact that, according to some embodiments, contemporaneous measurement information (e.g., roll, pitch, and/or yaw measurements) may be obtained from a positional sensor (e.g., an accelerometer) in first device 304A and used in the first and/or second distortion correction operations to correct the first and/or second portions of the captured image based on the corresponding contemporaneous measurement information. For example, if the first device 304A is rolled forward 3 degrees over the x-axis (i.e., pointing downward 3 degrees towards the desktop surface), then the captured first portion of the human subject may preferably be virtually rotated upward by a corresponding 3 degrees during its distortion correction operation so that the face of the human subject presents more level in the distortion-corrected first portion of the captured scene (324A). Likewise, if there is an initial assumption that objects or documents on flat desktop images in the scene need to be rotated upward by 90 degrees during their distortion correction operation in order to present level in the output image, then the measurement indicating that the first device 304A was rolled forward 3 degrees over the x-axis during the capture of the image may cause the device to instead only perform a virtual upward rotation of 87 degrees (i.e., 90 degrees minus 3 degrees) during its distortion correction operation so that the document presents more level in the distortion-corrected second portion of the captured scene (322A).

In some embodiments, a maximum permissible angular tilt correction may be defined for the system (e.g., if an image capture device is pointed too far upward towards the ceiling, it may simply not be possible to capture enough of a desktop surface in the same room for a successful virtual rotation operation to be applied to the desktop surface). In some implementations, a message could be raised to a user if they need to move closer (or farther) from an image capture device or change the roll, tilt, and/or yaw of the image capture device before being able to proceed with the simultaneous capture operations described herein.

In other embodiments, it may also be possible to obtain an estimate of any tilt in the desktop surface in the scene itself (e.g., through image analysis, or even user measurement and entry), which additional tilt could also be compensated for in the second distortion correction operation(s) applied to portions of the desktop surface.

Turning now to example 300B, there is no first device in proximity to the second device (302) with which to form a secure connection. In this example, image capture device (310) of second device (302) may have a sufficient quality, e.g., in terms of resolution, zoom, FOV, spatial resolution, focus, color quality, or any other imaging parameter, such that it may be used to perform the various techniques described herein, e.g., as part of an active videoconferencing session. As shown in example 300B, the image capture device 310 of the second device (302) has a wide FOV, represented by dashed lines 314B, which is capable of capturing both exemplary human subject 110 and exemplary document 120. As described above with reference to FIGS. 1 and 2 (and as will be described in greater detail below with reference to FIG. 4), in some embodiments, the distortion-corrected first portion of the captured scene comprising human subject 110 (labeled 324B) may be composited with (e.g., overlaid on top of or placed next to) the distortion-corrected second portion of the captured scene comprising exemplary document 120 (labeled 322B) and then displayed, stored, and or transmitted to another electronic device, e.g., via a video conferencing application (labeled 320B). Coordinate axis 316B again reflects the fact that, according to some embodiments, contemporaneous measurement information (e.g., roll, pitch, and/or yaw measurements) may be obtained from a positional sensor (e.g., an accelerometer) in second device 302 and used in the first and/or second distortion correction operations to correct the first and/or second portions of the captured image based on the corresponding contemporaneous measurement information.

Turning now to example 300C, a first device (304C) and a second device (302) are again in proximity to one another and have formed a secure connection with each other 308C (in this case, a wireless connection). In this example 300C, the image capture device 306 of the first device (304C) has a wide FOV, as represented by dashed lines 312C, which is capable of capturing both exemplary human subject 110 and exemplary document 120, while the image capture device 310 of the second device (302) has a different FOV, as represented by dashed lines 314C, which is capable of capturing exemplary human subject 110 (perhaps with a higher quality or spatial resolution level than image capture device 306 would be able). As described above with reference to FIGS. 1 and 2 (and as will be described in greater detail below with reference to FIG. 4), in some embodiments, the distortion-corrected first portion of the captured scene comprising human subject 110 and, in this case, captured by image capture device 310 of the second device 302 (labeled 324C) may be composited with (e.g., overlaid on top of or placed next to) the distortion-corrected second portion of the captured scene comprising exemplary document 120, in this case, captured by image capture device 306 of the first device 304C (labeled 322C) and then displayed, stored, and or transmitted to another electronic device, e.g., via a video conferencing application (labeled 320C). Coordinate axes 316C/D again reflect the fact that, according to some embodiments, contemporaneous measurement information (e.g., roll, pitch, and/or yaw measurements) may be obtained from a positional sensor (e.g., an accelerometer) in one or both of first device 304C and second device 302 and used in the respective first and/or second distortion correction operations to correct the first and/or second portions of the captured image based on the corresponding contemporaneous measurement information. Thus, as may now be appreciated, example 300C represents a hybrid scenario, wherein image capture devices that are integrated into different electronic devices are used to capture the different portions of the scene that will ultimately be cropped, distortion corrected, composited, and transmitted to another electronic device, e.g., as part of an active videoconferencing session.

### Exemplary Multi-Document Distortion Correction Operations for Simultaneous Subject and Desk Capture During Videoconferencing

FIG. 4 illustrates exemplary distortion correction operations for a multi-document scene 400, according to one or more embodiments. As discussed above with respect to FIG. 2, first cropped image portion 140 may be corrected via first distortion correction operation 210, to result in distortion-corrected first cropped image portion 240, and second cropped image portion 150 may be corrected via second distortion correction operation 220, to result in distortion-corrected second cropped image portion 250.

As alluded to above, in some embodiments, the second portion of the image (i.e., the regions within the captured scene containing the identified portions of a relevant surface in the scene) may comprise non-contiguous regions in the first image. In the example of FIG. 4, the second portion further comprises cropped regions around each of document 125 (i.e., bearing the letter ‘E’) and document 130 (i.e., bearing the letter ‘Z’). As with second cropped image portion 150, an independent third distortion correction operation 410 may be applied to the third cropped image portion 160 (i.e., containing document 125), resulting in distortion-corrected third cropped image portion 425, and an independent fourth distortion correction operation 420 may be applied to the fourth cropped image portion 170 (i.e., containing document 130 and occlusion 135), resulting in distortion-corrected fourth cropped image portion 430. In some cases, third and fourth distortion correction operations 410/420 may be similar to second distortion correction operation 220, i.e., they may each be configured to take regions cropped tightly around the relevant portion of the surface (e.g., the portion with relevant information), rotated such that any relevant textual information is upright in a final output image, and rectified, such that straight lines and edges of the surface remain straight after the respective distortion correction operations have been completed.

As mentioned above, in still other embodiments, an occlusion detection operation may be performed on the cropped image portions, e.g., fourth cropped image portion 170, and then at least one detected occlusion, e.g., object 135, may be excluded from the distortion correction operation on that portion (and/or have a strength of the second distortion correction operation be reduced in the region of the detected occlusion). As shown in FIG. 4, the fourth distortion correction operation 420 was able to exclude object 135 from the distortion correction operation (and perhaps apply a separate, appropriate distortion correction operation directly to the pixels making up object 135), thereby avoiding any unnatural distortions or skewing of object 135 in the distortion-corrected fourth cropped image portion 430. However, in other cases (e.g., in the case of fingers or hands appearing over the document 130), it may not be possible to exclude occlusions altogether, thus a tunable strength parameter may be employed to strike an acceptable balance between providing an appropriate amount of distortion correction and not causing the object 135 to appear overly unnatural in distortion-corrected fourth cropped image portion 430.

In some embodiments, one or more of the distortion-corrected first cropped image portion 240 and the other distortion-corrected cropped image portion(s) containing identified portions of surfaces in the captured scene (e.g., portions 430/250/425) may be composited into a single first output image 440. As shown in exemplary user interface 450, the distortion-corrected cropped image portions 430/250/425 may be composited in a way that reflects their relative positions in the scene (e.g., the documents 130, 120, and 125 are laid out from left-to-right on the desktop surface in the scene in front of human subject 110, thus their respective composited distortion-corrected cropped image portions 430′/250′/425′ may also be laid out from left-to-right in the composited first output image 440, spelling ‘ZAE’). If desired, the composited distortion-corrected first cropped image portions 240′, comprising the face of the human subject may be overlaid with (or placed next to) the other composited distortion-corrected cropped image portions in the first output image 440 before transmission to videoconferencing session participant. It is to be understood that the relative placement, as well as which distortion-corrected cropped portions to include in the first output image may also be specified by a user, as desired.

### Exemplary Methods of Performing Simultaneous Subject and Desk Capture During Videoconferencing

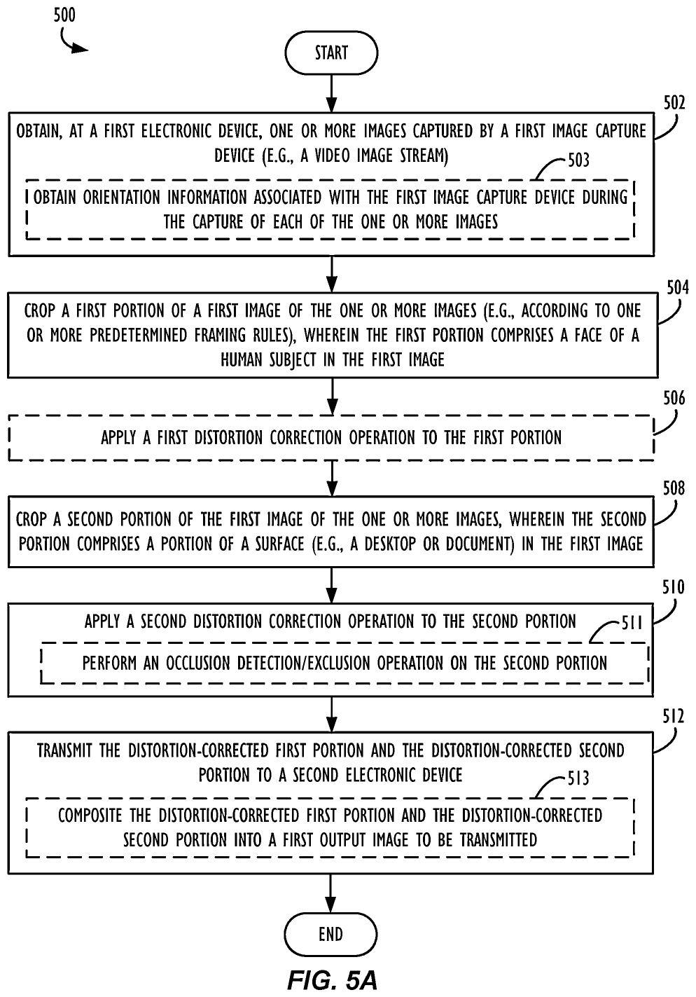

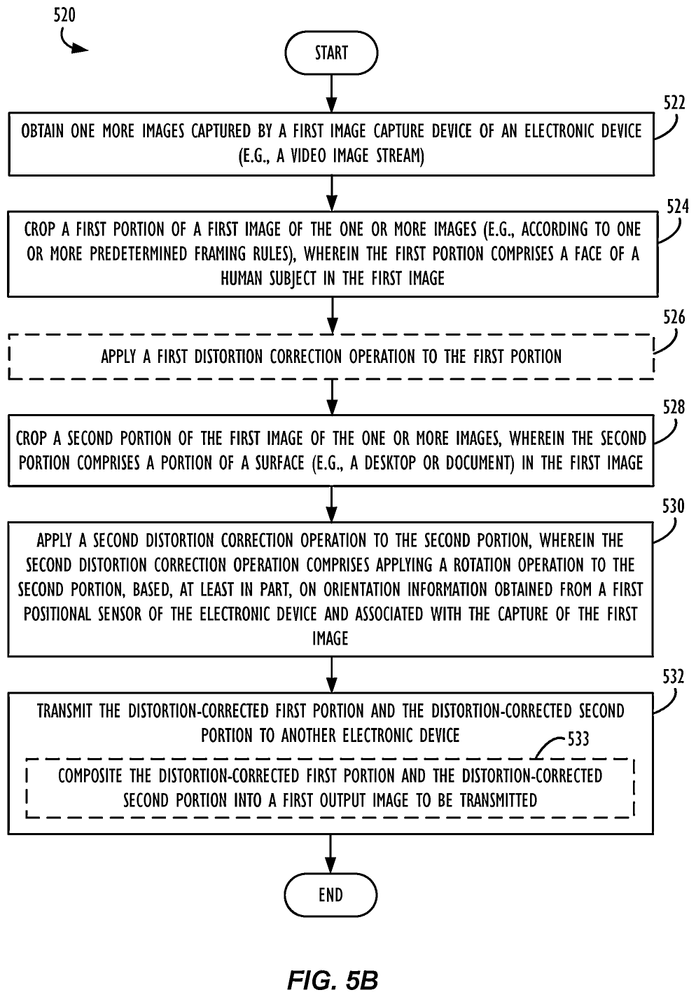

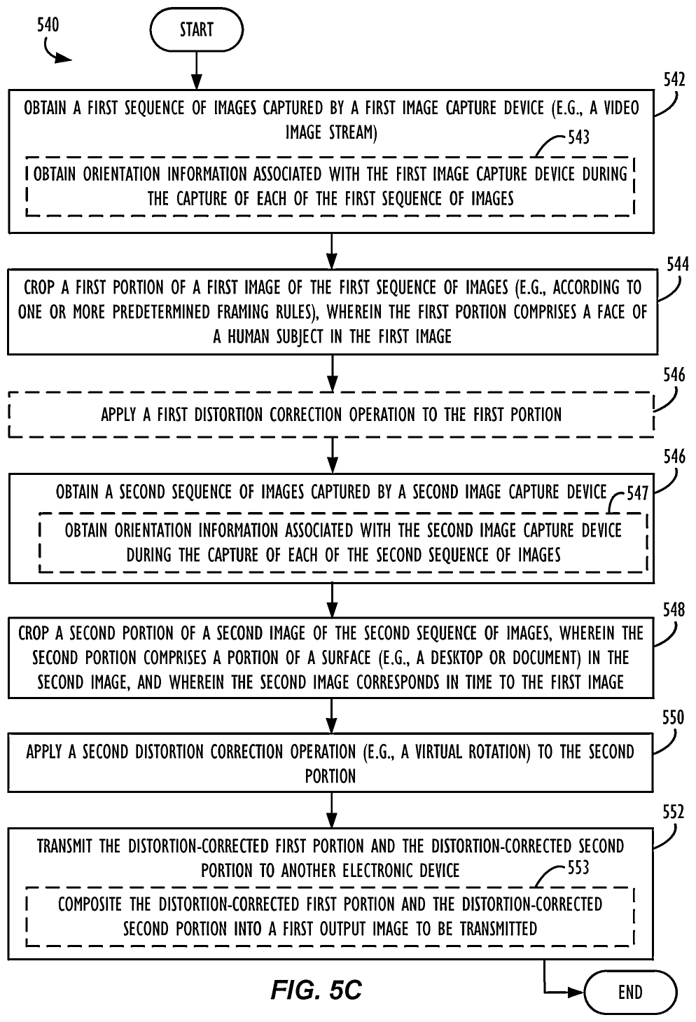

FIG. 5A is a flow chart 500, illustrating a method of performing simultaneous subject and desk capture during videoconferencing, according to various embodiments. First, at Step 502, the method 500 may obtain, at a first electronic device, one or more images captured by a first image capture device (e.g., a video image stream, such as a video image stream that may have been stabilized by an optical image stabilization (OIS) system, electronic image stabilization (EIS) system, or the like). According to some embodiments, at Step 503, the first electronic device may obtain orientation information associated with the first image capture device during the capture of each of the one or more images (e.g., accelerometer readings contemporaneous with the capture of the first image). Next, at Step 504, the method 500 may crop a first portion of a first image of the one or more images (e.g., according to one or more predetermined framing rules), wherein the first portion comprises a face of a human subject in the first image. Next, at Step 506, the method 500 may optionally apply a first distortion correction operation to the first portion, e.g., a perspective distortion correction, barrel lens distortion correction, a geometric distortion correction, or the like. Distortion correction may be desired if, e.g., the first portion of the first image is cropped from a part of the first image's FOV that experiences an unwanted amount of distortion.

At Step 508, the method 500 may next crop a second portion of the first image of the one or more images (e.g., a different portion than the first cropped portion from Step 504), wherein the second portion comprises a portion of a surface (e.g., a desktop or document) present in the first image. Next, at Step 510, the method 500 may apply a second distortion correction operation to the second portion (e.g., a different type of distortion operation than that optionally applied at Step 503). As discussed above, the second distortion correction operation may comprise one or more of: a fisheye distortion correction, a perspective distortion correction, barrel lens distortion correction, a rotation correction operation (e.g., a spherical rotation operation), a keystone distortion correction operation, a geometric distortion correction operation, or the like. One goal of the second distortion correction operation may be to cause the cropped surface in the second portion of the first image to be free from unwanted distortion and rotated to an appropriate angle and view so that it may be transmitted to another user in a user-readable fashion, e.g., upright, cropped tightly around the relevant portion of the surface (e.g., the portion with relevant information), and rectified, such that straight lines and edges of the surface remain straight (and rectangles remain rectangles) after the distortion correction operations have been completed. In some embodiments, at Step 511, the method 500 may also optionally perform an occlusion detection/exclusion operation on the second portion of the first image. As described above, occlusions within the second portion of the first image may comprise portions of a user's hands, fingers, writing instruments, or other unwanted objects located on or above the detected surface in the captured scene. In some embodiments, identified occlusions may be excluded from distortion correction operations that are applied to the other pixels making up the second portion of the first image. In other embodiments, a tuning parameter may be employed to decrease the strength or extent of the distortion correction operations that are applied to the pixels in the second portion of the first image that are a part of the detected occlusion region. In still other embodiments, pixels from previously-captured images where the detected surface is not occluded may be used to replace the versions of the pixels in the captured images where the surface is occluded.

At Step 512, the method 500 may transmit the distortion-corrected first portion and the distortion-corrected second portion to a second electronic device. In some embodiments, at Step 513, the method 500 may first composite the distortion-corrected first portion and the distortion-corrected second portion into a first output image to be transmitted, as shown above, e.g., in FIGS. 3 and 4. In some cases, the first and second portions may be individually processed, e.g., in terms of brightness, contrast, color correction, etc., before being composited and transmitted to a second electronic device. In some implementations, the transmitting of the first output image (and/or the individual distortion-corrected first portion and the distortion-corrected second portion) to a second electronic device may be configured to occur prior to the first electronic device obtaining of a second image of the one or more images, wherein the second image is captured subsequently to the first image.

FIG. 5B is a flow chart 520, illustrating a method of performing simultaneous subject and desk capture during videoconferencing using a first image capture device of an electronic device, according to various embodiments. First, at Step 522, the method 520 may obtain one more images captured by a first image capture device of an electronic device (e.g., a video image stream). Next, at Step 524, the method 520 may crop a first portion of a first image of the one or more images (e.g., according to one or more predetermined framing rules), wherein the first portion comprises a face of a human subject in the first image. Next, at Step 526, the method 520 may optionally apply a first distortion correction operation to the first portion.

At Step 528, the method 520 may crop a second portion of the first image of the one or more images, wherein the second portion comprises a portion of a surface (e.g., a desktop or document) in the first image. Next, at Step 530, the method 520 may apply a second distortion correction operation to the second portion, wherein the second distortion correction operation may, e.g., comprise applying a rotation operation to the second portion, based, at least in part, on orientation information obtained from a first positional sensor of the electronic device and associated with the capture of the first image. Finally, at Step 532, the method 520 may transmit the distortion-corrected first portion and the distortion-corrected second portion to a second electronic device. In some embodiments, at Step 533, the method 520 may first composite the distortion-corrected first portion and the distortion-corrected second portion into a first output image to be transmitted, as shown above, e.g., in FIGS. 3 and 4.

FIG. 5C is a flow chart 540, illustrating a method of performing simultaneous subject and desk capture during videoconferencing using first and second image capture devices, according to various embodiments. First, at Step 542, the method 540 may obtain a first sequence of images captured by a first image capture device (e.g., a video image stream). According to some embodiments, at Step 543, the method 540 may obtain orientation information associated with the first image capture device during the capture of each of the first sequence of images.

Next, at Step 544, the method 540 may crop a first portion of a first image of the first sequence of images (e.g., according to one or more predetermined framing rules), wherein the first portion comprises a face of a human subject in the first image and, at Step 546, optionally apply a first distortion correction operation to the first portion, e.g., based, at least in part, on the orientation information obtained at Step 543.

Next, at Step 546, the method 540 may obtain a second sequence of images captured by a second image capture device. According to some embodiments, at Step 547, the method 540 may obtain orientation information associated with the second image capture device during the capture of each of the second sequence of images. Next, at Step 548, the method 540 may crop a second portion of a second image of the second sequence of images, wherein the second portion comprises a portion of a surface (e.g., a desktop or document) in the second image, and wherein the second image corresponds in time to the first image. At Step 550, the method 500 may optionally apply a second distortion correction operation (e.g., a virtual rotation operation performed in software) to the second portion, e.g., based, at least in part, on the orientation information obtained at Step 547.

According to one embodiment, the virtual rotation operation may be defined, such that: a rotation vector (Θx, Θy, Θz), and the camera projection matrix, P, may be determined by the principal point (Ox, Oy), and a focal length, f. Then, the output of the virtual rotation operation will be the determined perspective transformation, e.g., as defined by the projection matrix, P.

According to some such embodiments, the perspective transformation may be determined by performing the following steps:
Step 1. Calculate the 3×3 Rotation matrix, R, from the rotation vector (Θx, Θy, Θz).
Step 2. Calculate the 3×3 perspective transform, T, from the rotation matrix, R, as follows:

$$\begin{matrix}f & 0 & Ox \\ 0 & f & Oy \\ 0 & 0 & 1\end{matrix} .$$

In other embodiments, the perspective transformation equation of Step 2 may also involve different projection matrices, i.e., P values, e.g., taking the form: T=Pᵥᵢᵣₜᵤₐₗ*R*inverse (P_{original}), where P_{original} is a projection matrix determined by the input camera's calibration parameters, and Pᵥᵢᵣₜᵤₐₗ is a projection matrix that can be controlled (e.g., changing the value of f to mimic a camera with a different focal length, etc.).
Step 3. Apply the calculated perspective transformation, T, to the image.

As may now be understood, the global projection matrix, P, may be defined by the 3×3 matrix having values of:

$$t = p * r * inverse ( P ) .$$

Finally, at Step 552, the method 540 may transmit the distortion-corrected first portion and the distortion-corrected second portion to another electronic device. In some embodiments, at Step 553, the method 540 may first composite the distortion-corrected first portion and the distortion-corrected second portion into a first output image to be transmitted, as shown above, e.g., in FIGS. 3 and 4.

### Exemplary Electronic Computing Devices

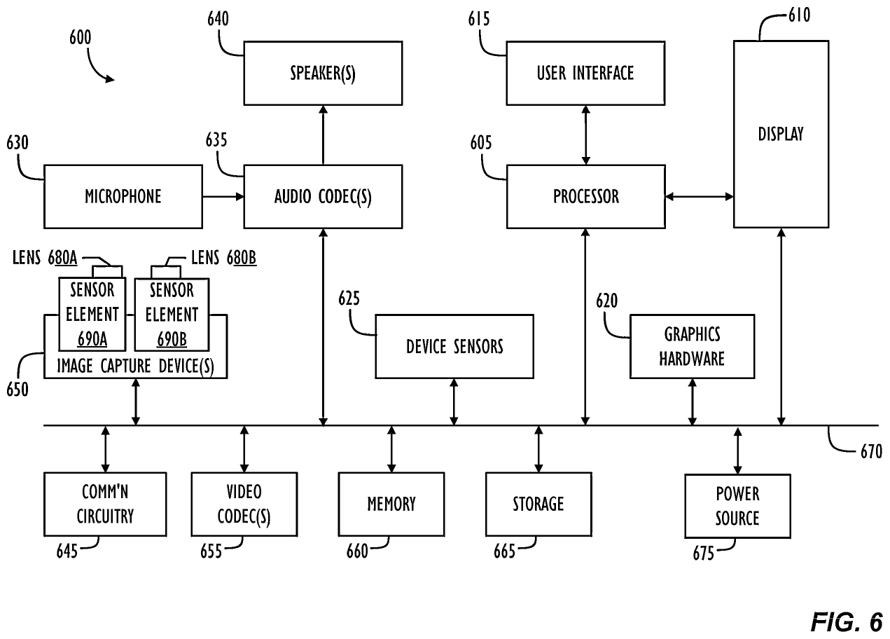

Referring now to FIG. 6, a simplified functional block diagram of illustrative programmable electronic computing device 600 is shown according to one embodiment. Electronic device 600 could be, for example, a mobile telephone, personal media device, portable camera, or a tablet, notebook or desktop computer system. As shown, electronic device 600 may include processor 605, display 610, user interface 615, graphics hardware 620, device sensors 625 (e.g., proximity sensor/ambient light sensor, accelerometer, inertial measurement unit, and/or gyrometer), microphone 630, audio codec(s) 635, speaker(s) 640, communications circuitry 645, image capture device 650, which may, e.g., comprise multiple camera units/optical image sensors having different characteristics or abilities (e.g., Still Image Stabilization (SIS), HDR, OIS systems, optical zoom, digital zoom, etc.), video codec(s) 655, memory 660, storage 665, and communications bus 670.

Processor 605 may execute instructions necessary to carry out or control the operation of many functions performed by electronic device 600 (e.g., such as the generation, processing, and/or streaming of images and video data in accordance with the various embodiments described herein). Processor 605 may, for instance, drive display 610 and receive user input from user interface 615. User interface 615 can take a variety of forms, such as a button, keypad, dial, a click wheel, keyboard, display screen and/or a touch screen. User interface 615 could, for example, be the conduit through which a user may view a captured video stream and/or indicate particular image frame(s) that the user would like to capture (e.g., by clicking on a physical or virtual button at the moment the desired image frame is being displayed on the device's display screen). In one embodiment, display 610 may display a video stream as it is captured while processor 605 and/or graphics hardware 620 and/or image capture circuitry contemporaneously generate and store the video stream in memory 660 and/or storage 665. Processor 605 may be a system-on-chip (SOC) such as those found in mobile devices and include one or more dedicated graphics processing units (GPUs). Processor 605 may be based on reduced instruction-set computer (RISC) or complex instruction-set computer (CISC) architectures or any other suitable architecture and may include one or more processing cores. Graphics hardware 620 may be special purpose computational hardware for processing graphics and/or assisting processor 605 perform computational tasks. In one embodiment, graphics hardware 620 may include one or more programmable graphics processing units (GPUs) and/or one or more specialized SOCs, e.g., an SOC specially designed to implement neural network and machine learning operations (e.g., convolutions) in a more energy-efficient manner than either the main device central processing unit (CPU) or a typical GPU, such as Apple's Neural Engine processing cores.

Image capture device 650 may comprise one or more camera units configured to capture images, e.g., images which may be processed to generate framed and/or distortion-corrected versions of said captured images, e.g., in accordance with this disclosure. Output from image capture device 650 may be processed, at least in part, by video codec(s) 655 and/or processor 605 and/or graphics hardware 620, and/or a dedicated image processing unit or image signal processor incorporated within image capture device 650. Images so captured may be stored in memory 660 and/or storage 665. Memory 660 may include one or more different types of media used by processor 605, graphics hardware 620, and image capture device 650 to perform device functions. For example, memory 660 may include memory cache, read-only memory (ROM), and/or random access memory (RAM). Storage 665 may store media (e.g., audio, image and video files), computer program instructions or software, preference information, device profile information, and any other suitable data. Storage 665 may include one more non-transitory storage mediums including, for example, magnetic disks (fixed, floppy, and removable) and tape, optical media such as CD-ROMs and digital video disks (DVDs), and semiconductor memory devices such as Electrically Programmable Read-Only Memory (EPROM), and Electrically Erasable Programmable Read-Only Memory (EEPROM). Memory 660 and storage 665 may be used to retain computer program instructions or code organized into one or more modules and written in any desired computer programming language. When executed by, for example, processor 605, such computer program code may implement one or more of the methods or processes described herein. Power source 675 may comprise a rechargeable battery (e.g., a lithium-ion battery, or the like) or other electrical connection to a power supply, e.g., to a mains power source, that is used to manage and/or provide electrical power to the electronic components and associated circuitry of electronic device 600.

It is to be understood that the above description is intended to be illustrative, and not restrictive. For example, the above-described embodiments may be used in combination with each other. Many other embodiments will be apparent to those of skill in the art upon reviewing the above description. The scope of the invention therefore should be determined with reference to the appended claims, along with the full scope of equivalents to which such claims are entitled.

What is claimed is:

1. A method, comprising:
obtaining, at a first electronic device, one more images captured by a first image capture device;
cropping a first portion of a first image of the one or more images, wherein the first portion comprises a face of a human subject in the first image;
applying a first distortion correction operation to the first portion;
cropping a second portion of the first image of the one or more images, wherein the second portion comprises a portion of a surface in the first image;
applying a second distortion correction operation to the second portion; and
transmitting the distortion-corrected first portion and the distortion-corrected second portion to a second electronic device.

2. The method of claim 1, wherein the one or more images comprises a video image stream.

3. The method of claim 2, wherein the video image stream comprises a stabilized video image stream.

4. The method of claim 1, wherein the transmitting of the first output image distortion-corrected first portion and the distortion-corrected second portion to a second electronic device occurs prior to the obtaining of a second image of the one or more images, wherein the second image is captured subsequently to the first image.

5. The method of claim 1, further comprising:
obtaining orientation information associated with the first image capture device during the capture of each of the one or more images.

6. The method of claim 1, wherein the first image capture device is connected to first electronic device in one of the following ways: a wired connection, a wireless connection, or via being embedded in first electronic device.

7. The method of claim 1, wherein cropping a first portion of a first image of the one or more images further comprises cropping the first portion according to one or more predetermined framing rules.

8. The method of claim 1, wherein the second portion of the first image is detected automatically using a detector.

9. The method of claim 8, wherein the detector comprises a deep neural network (DNN) trained to locate particular surfaces in images.

10. The method of claim 1, further comprising:
tracking a location and size of the portion of the surface across the one or more images captured by the first image capture device.

11. The method of claim 1, wherein the portion of the surface comprises two or more non-contiguous regions in the first image.

12. The method of claim 1, wherein the portion of the surface is defined by a user gesture captured at the first image capture device.

13. The method of claim 1, wherein the first and second distortion correction operations are different.

14. The method of claim 5, wherein the second distortion correction operation comprises applying a rotation operation to the second portion, based, at least in part, on orientation information associated with the first image capture device during the capture of the first image.

15. The method of claim 14, wherein the orientation information associated with the first image capture device during the capture of the first image comprises one or more of pitch, roll, and yaw.

16. The method of claim 14, wherein the second distortion correction operation is further based on an estimated orientation of the portion of the surface in the first image.

17. The method of claim 1, further comprising:
compositing the distortion-corrected first portion and the distortion-corrected second portion into a first output image,
wherein transmitting the distortion-corrected first portion and the distortion-corrected second portion to the second electronic device comprises transmitting the first output image to the second electronic device.

18. The method of claim 1, wherein cropping the second portion of the first image of the one or more images further comprises:
performing an occlusion detection operation on the second portion; and
excluding at least one detected occlusion from the second distortion correction operation.

19. An electronic device, comprising:
a memory;
a first image capture device;
a first positional sensor; and
one or more processors operatively coupled to the memory, wherein the one or more processors are configured to execute instructions causing the one or more processors to:
obtain one more images captured by the first image capture device;
crop a first portion of a first image of the one or more images, wherein the first portion comprises a face of a human subject in the first image;
apply a first distortion correction operation to the first portion;
crop a second portion of the first image of the one or more images, wherein the second portion comprises a portion of a surface in the first image;
apply a second distortion correction operation to the second portion, wherein the second distortion correction operation comprises applying a rotation operation to the second portion, based, at least in part, on orientation information obtained from the first positional sensor and associated with the capture of the first image; and
transmit the distortion-corrected first portion and the distortion-corrected second portion to another electronic device.

20. A non-transitory computer readable medium comprising computer readable instructions executable by one or more processors to:
obtain a first sequence of images captured by a first image capture device;
crop a first portion of a first image of the first sequence of images, wherein the first portion comprises a face of a human subject in the first image;
apply a first distortion correction operation to the first portion;
obtain a second sequence of images captured by a second image capture device;
crop a second portion of a second image of the second sequence of images, wherein the second portion comprises a portion of a surface in the second image, and wherein the second image corresponds in time to the first image;
apply a second distortion correction operation to the second portion, wherein the second distortion correction operation comprises applying a rotation operation to the second portion; and
transmit the distortion-corrected first portion and the distortion-corrected second portion to another electronic device.
